(19) United States
(12) Patent Application Publication
(10) Pub. No.: US 2005/0285291 A1
(43) Pub. Date: Dec. 29, 2005

(54) Methods to produce hierarchically-ordered complex structures and composites thereof

(75) Inventors: Anthony Yu-Chung Ku, Rexford, NY (US); Sergio Paulo Martins Loureiro, Saratoga Springs, NY (US); Mohan Manoharan, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/874,989

(22) Filed: Jun. 23, 2004

(51) Int. Cl. C04B 33/32

(52) U.S. Cl. 264/44; 264/611; 264/426; 264/435; 264/624; 264/437

(57) ABSTRACT

The present invention is directed toward methods of making hierarchically-ordered complex structures and composites thereof. Such structures are generally ordered on multiple length scales. Typically, at least one length scale comprises mesoscale dimensionality. Such methods generally utilize an organized, directionally-oriented combination of multiple fields to fabricate such structures and articles of manufacture made by the above-described methods, and in applications using such articles manufactured by the above-described process. The present invention is also directed toward novel composites, structures, and articles of manufacture made by the above-described processes. In some embodiments, such structures are composites of two or more such hierarchically-ordered complex substructures. In additional or other embodiments, such hierarchically-ordered complex substructures are combined, or integrated into, other structures that would not be considered hierarchically-ordered complex structures taken separately.

### TECHNICAL FIELD

The present invention relates generally to methods for preparing hierarchically-ordered ceramic structures, and more specifically to methods for preparing such structures using a combination or multiplicity of ordering fields.

### BACKGROUND INFORMATION

Nature provides a myriad of examples in which hierarchical structures are formed through highly coupled and often concurrent synthesis and assembly processes over multiple length scales. See Aksay et al., “Biomimetic Pathways for Assembling Inorganic Thin Films, ” Science, vol. 273, pp. 892-898 (1996). The existence of these hierarchical inorganic structures, such as abalones and diatoms, has both biological and evolutionary significance. The special architecture of the natural structures makes them simultaneously hard, strong, and tough. Consequently, it has been a long-sought goal to mimic the natural processes responsible for these hierarchical structured architectures using biomimetic strategies to control the structural organization and thereby produce useful materials with similar architectures, comprising multiple length scales including the mesoscale regime, for a variety of diverse applications.

In seminal work by Mobil researchers, mesoporous silica with ordering lengths of 3-30 nm and mesoporosity of up to 100 Å was obtained using amphiphilic surfactants as the structure-directing agents. See C. T. Kresge et al., “Ordered mesoporous molecular sieves synthesized by a liquid-crystal template mechanism,” Nature, vol. 359, pp. 710-712 (1992), and Beck et al., “A New Family of Mesoporous Molecular Sieves Prepared with Liquid Crystal Templates,” J. Am. Chem. Soc., vol. 114, pp. 10834-10843 (1992). Reported therein, elongated micellar tubules, comprising surfactant molecules spontaneously self-assembled into arrays, wherein silica precursor occupied the interstitial spaces between the micellar tubules. Acidification was shown to polymerize (precipitate) the silica material forming mesostructured arrays, and calcination served to remove the organic material leaving behind a mesostructured material. The techniques described did not, however, produce any long-range ordering—long-range ordering being on the order of hundreds of nanometers. Instead, only short-range ordering (e.g., local hexagonal or cubic or lamellar packing) was observed.

By forming the above-described materials on an ordered surface, such as mica or graphite, Aksay and co-workers were able to achieve some degree of long-range ordering of the mesostructured materials. See Aksay et al., “Biomimetic Pathways for Assembling Inorganic Thin Films,” Science, vol. 273, pp. 892-898 (1996). However, multilayered films on a mica or graphite surface were shown to become increasingly disordered with increasing distance from the surface. Thus, while this method introduced substrate-induced ordering of the mesostructured materials, it was limited to substantially two-dimensions and to the orderings available with suitable surfaces.

Later work by Aksay and co-workers involved the formation of such silica mesostructures in patterned capillary-like channels. See Trau et al., “Microscopic patterning of oriented mesoscopic silica through guided growth,” Nature, vol. 390, pp. 674-676 (1997). Here, suspension of such elongated micellar mesostructures were drawn into the capillary-like channels. This work further included application of an electric field, in a direction tangential to the surface, so as to induce electro-osmotic flow and provide for localized Joule heating to enhance the rate of silica polymerization.

Stucky and co-workers have used magnetic fields to align elongated micellar assemblies of surfactant and unpolymerized silica precursor. See Tolbert et al., “Magnetic Field Alignment of Ordered Silicate-Surfactant Composites and Mesoporous Silica,” Science, Vol. 278, 264 (1997). The high viscoelasticity of the oriented silicate-surfactant liquid crystals so formed by this method permits their removal from the magnetic field for an extended period without loss of orientation. Although order is retained for a period of time upon removal from the field, the liquid crystal phase is still sufficiently fluid that it does not maintain its structure unless the silica is polymerized. The ordering is also partially degraded by the polymerization process. This work further required an extremely high magnetic field provided by the magnet of a nuclear magnetic resonance (NMR) spectrometer (11.7 T). Use of such field strengths in manufacturing processes would likely be problematic and expensive.

Additionally, Stucky and co-workers have prepared hierarchically-ordered oxide structures comprising a tertiary level of ordering. Moreover, by employing a variety of sol-gel mesophase chemistries, such structures were prepared with a variety of different oxides including silica, Nb₂O₅, TiO₂, ZrO₂, WO₃, AlSiO_{3.5}, and SiTiO₄. See Yang et al., “Hierarchically Ordered Oxides,” Science, vol. 282, pp. 2244-2246 (1998); and U.S. Pat. No. 6,541,539 to Yang et al. In the methods described therein, a sol-gel ceramic precursor solution is used which comprises PLURONIC structure-directing block copolymer species that induce the formation of elongated micellar assemblies that, in the presence of ceramic precursor, as above, self-assemble into mesostructured arrays. A channeled mold is placed on a surface and the channels are sequentially filled with a suspension of LATEX spheres (200 nm in diameter) and the ceramic precursor sol. The material is allowed to precipitate and gel, the mold is removed, and the hierarchically ordered structures are calcined. However, this technique requires the addition of pre-fabricated spheres and is dependent upon pre-fabricated molds—adding to the fabrication complexity and precluding universal manufacturing ability.

Yang and co-workers have observed flow induced alignment of elongated (“wormlike”) silicate-containing micellar assemblies in a Couette flow cell between two coaxial cylinders. See Kim et al., “Flow-Induced Silica Structure During In Situ Gelation of Wormy Micellar Solutions,” Langmuir, vol. 16, pp. 4761-4765 (2000). However, such flow-induced alignment could be perceived as placing severe restrictions on manufacturing processes.

Despite the above-mentioned efforts in nanostructuring materials, the fabrication of hierarchically ordered structures at multiple length scales has remained an experimental challenge. Notwithstanding the limitations inherent in the above-mentioned processes, such structures are important both for systematic fundamental study of structure-property relationships and for their technological promise in applications such as catalysis, selective separations, sensor arrays, etc.—especially when incorporating structure at the mesoscale. Many applications for macro- and mesoporous metal oxides require structural ordering at multiple length scales. Thus, there exists a great need for hierarchically-ordered materials and the demand for improved methods of forming such materials, especially universal methods, remains. Toward this end, a simple, manufacturing-friendly and universally-applicable method for generating hierarchically-ordered complex structures would be extremely beneficial.

### BRIEF DESCRIPTION OF THE INVENTION

The present invention is directed toward methods of making one or more hierarchically-ordered complex structures and composites thereof. Such structures are generally ordered on multiple length scales. Typically, at least one length scale comprises mesoscale dimensionality. Such methods generally utilize an organized, directionally-oriented combination of multiple fields to fabricate such structures and are typically used in concert with micelle-forming species possessing a tendency to self-assemble.

Depending upon the embodiment(s), the hierarchically ordered complex structures may comprise structure in from one to three dimensions in any of the multiple length scales encompassed by the composite. Furthermore, the present invention, in some embodiments, generally provides for the fabrication of such hierarchically ordered complex structures from a multiplicity (i.e., two or more) of ceramic and/or ceramic precursor materials.

Generally, the methods of the present invention comprise the steps of: providing a complex precursor mixture, the mixture comprising: at least one solvent, a quantity of at least one organic templating agent, a quantity of at least one ceramic precursor, and a quantity of at least one acid; applying a combination of at least two external fields; and forming hierarchically-ordered complex composites from the complex precursor mixture, wherein the at least two external fields provide directionality and organization to the hierarchically-ordered complex composite formation. In some embodiments, the combination of at least two external fields comprises at least two different field types oriented in at least two different directions.

The present invention is also directed toward novel composites, structures, and articles of manufacture made by the above-described processes. In some embodiments, such structures are composites of two or more such hierarchically-ordered complex substructures. In additional or other embodiments, such hierarchically-ordered complex substructures are combined, or integrated into other structures that would not be considered hierarchically-ordered complex structures taken separately.

The present invention represents a significant advance over the prior art in that it provides for a generally universal method of making such hierarchically-ordered complex structures by using a multiplicity of externally-applied fields to direct ordering in one or more size regimes and in one or more dimensions.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates electric and magnetic fields that are aligned according to an embodiment of the present invention outlined in Example 1;

FIGS. 2A and B depict a control scenario in which a one-dimensional hierarchically-ordered complex structure possessing random orientation of silica particles 201 and magnetite particles 203 (A) results when produced without the application of external fields to yield the structure shown in micrograph (B), according to an embodiment of the present invention;

FIGS. 3A and B depict a scenario in which a one-dimensional hierarchically-ordered complex structure possessing orientation of elongated silica fibers 301 and randomness of magnetite particles 203 (A) when produced with the application of an electric field to yield the structure shown in micrograph (B), according to an embodiment of the present invention;

FIGS. 4A and B depict a scenario in which a one-dimensional hierarchically-ordered complex structure possessing random orientation of silica particles 201 and oriented magnetite particles 203 (A) results when produced with the application of a magnetic field to yield the structure shown in micrograph (B), according to an embodiment of the present invention;

FIGS. 5A and B depict a scenario in which a one-dimensional hierarchically-ordered complex structure possessing orientation of elongated silica fibers 301 and magnetite particles 203 (A) results when produced with the application of external electric and magnetic fields to yield the structure shown in micrograph (B), according to an embodiment of the present invention;

FIG. 6 illustrates a mixture comprising an aqueous dispersion of magnetite particles 601 and silica particles 602, according to an embodiment of the present invention;

FIG. 7 illustrates the mixture of FIG. 6 in a container 704 and being exposed to an electric field and magnetic fields to provide for the formation of a 3-D hierarchically-ordered complex structure, according to an embodiment of the present invention; and

FIG. 8 illustrates the 3-D hierarchically-ordered complex structure of FIG. 7 after gelation and removal from container 704, in accordance with an embodiment of the present invention.

### DETAILED DESCRIPTION OF THE INVENTION

In the following description, specific details are set forth such as specific quantities, sizes, etc. to provide a thorough understanding of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

While most of the terms used herein will be recognizable to those of skill in the art, the following definitions are nevertheless put forth to aid in the understanding of the present invention. It should be understood, however, that when not explicitly defined, terms should be interpreted as adopting a meaning presently accepted by those of skill in the art.

“Hierarchically-ordered,” as defined herein, refers to structures having multiple levels of dimensional ordering, i.e., structure in multiple size regimes. Such ordering can be found in structures comprised of from one to three dimensions. An apartment building, for example, is two-level hierarchically-ordered (second ordered) structure in that it is a single structure (the building) comprised of multiple subunits (the apartments).

“Ceramic,” as defined herein, refers to materials comprised of oxides, nitrides, carbides, and chalcogenides of metal and/or Group 13 (B, Al, Ga, In, Tl) elements. Ceramics can be mixed metal oxides, aluminasilicates, combinations of other ceramic compounds, and combinations thereof.

“Complex structures,” as defined herein, refer to structures comprised of more than one material or compound. Such structures are essentially mixtures of a ceramic material with at least one other material that is typically ceramic as well.

“Composites” of complex structures, as defined herein, generally refers to complex superstructures formed by the integration and/or combination of two or more complex structures. More specifically, such composite structures can be the integration and/or combination of hierarchically-ordered complex structures into and/or with other structures that may, or may not be hierarchically-ordered.

“Microscale,” as defined herein, refers to dimensionality (i.e., size regime) of ≦˜20 Å (angstroms). This is a term that has arisen in the art and should not be confused with “micron-scale,” defined below. Correspondingly, things that possess microscale structure are termed “microstructured,” and things that possess microscale pores are termed “microporous.”

“Mesoscale,” as defined herein, refers to dimensionality of ˜20Å-500 Å. Correspondingly, things that possess mesoscale structure are termed “mesostructured,” and things that possess mesoscale pores are termed “mesoporous.”

“Nanoscale,” as defined herein, refers to dimensionality of 1 nanometer (nm) to 100 nm. As 1 nm equals 10 Å, the mesoscale size regime falls within the nanoscale size regime.

“Micron-scale” as defined herein, refers to dimensionality of ˜100 nm to 100 micrometers (μm). Micron-scale should not be confused with microscale, as defined above. “Macroscale,” as defined herein, refers to dimensionality of ≧100 μm. This dimensional minimum is roughly the threshold of what is visible with the naked eye.

“Amphiphilic,” as defined herein, refers to polar compounds or molecules, such as surfactants, that have a water soluble (hydrophilic) end and a hydrocarbon soluble (hydrophobic) end. Such species can be ionic or non-ionic. When dispersed in, for example, an aqueous medium, such species self-assemble into “micelles” with their hydrophobic ends directed toward the interior of the micelle so as to minimize surface energy.

“Micellar assembly,” as defined herein, refers to the self-assembly of elongated (e.g., “worm-like”) micelles into arrays, the micelles comprising amphiphilic species, as above, and typically comprising another material (e.g., a ceramic precursor) on their exterior and/or in the interstitial spaces within the assembly (array).

“Polymerization,” as defined herein, includes the common definition wherein monomers are reacted to form a one dimensional macromolecule, but is extended to include the formation of two- and three-dimensional macromolecules (solids).

“Shear-flow fields,” as defined herein, refers to the hydrodynamic fields that develop within a fluid due to flow. The flow can contain linear, rotational, and torsional components and combinations of these. In addition, the flow can be steady-state, oscillatory or transitory.

The present invention is directed toward methods of making hierarchically-ordered complex structures and composites thereof. Such structures are generally ordered on multiple length scales, wherein at least one length scale comprises mesoscale dimensionality. Such methods generally utilize an organized, directionally-oriented combination of multiple fields to fabricate such structures.

Depending upon the embodiment(s), the hierarchically-ordered complex structures may comprise structure in from one to three dimensions in any of the multiple length scales encompassed by the composite. Furthermore, the present invention, in some embodiments, generally provides for the fabrication of such hierarchically-ordered complex structures from a multiplicity (i.e., two or more) of ceramic and/or ceramic precursor materials.

Generally, the methods of the present invention comprise the steps of: providing a complex precursor mixture, the mixture comprising: at least one solvent, a quantity of at least one organic templating agent, a quantity of at least one ceramic precursor, and a quantity of at least one acid; applying a combination of at least two external fields; and forming hierarchically-ordered complex structures from the complex precursor mixture, wherein the at least two external fields provide directionality and organization to the hierarchically-ordered complex structure formation. In some embodiments, the combination of at least two external fields comprise at least two different field types oriented in at least two different directions. Such external fields are generally selected from the group consisting of magnetic fields, electric fields, shear-flow fields, and combinations thereof.

Typically, the organic templating agents present in the complex precursor mixture are amphiphilic surfactants or block copolymers, but can also be lipids, proteins, and/or long chain alcohols such as polyvinyl alcohol. Suitable organic templating agents include, but are not limited to cetyltrimethylammonium chloride (CTAC), PLURONIC block copolymers (polyethylene oxide-polypropylene oxide-polyethylene oxide triblock copolymers), cetyltrimethylammonium bromide, cetyltrimethylammonium tosylate, and combinations thereof. Such organic templating agents further serve as structure-directing agents. In an aqueous medium, for example, such species assemble into elongated micelles, wherein hydrophobic ends are directed inward and hydrophilic ends are directed outward. These elongated micelles, in turn, self-assemble into micellar assemblies. Dependent upon the types of organic templating agents used, these elongated micellar assemblies can be engineered to be differentially responsive to a multiplicity of identical or dissimilar fields of varying field strength and directionality.

Typically, the complex precursor comprises at least one ceramic precursor that is capable of undergoing controlled precipitation in the surrounding and interstitial spaces or channels of the above-described micellar assemblies. Examples of such ceramic precursors include, but are not limited to, tetraethoxysilane (TEOS), sodium silicate, colloidal silica, aluminum butoxide, titanium ethoxide, titanium isopropoxide, and combinations thereof. In some embodiments, upon acidification (with a suitable protic acid such as, but not limited to, HCl, HBr, HF, HI, acetic acid, HNO₃, H₂SO₄, HPO₄, HClO₄, and combinations thereof), these ceramic precursors polymerize (i.e., reactively precipitate) to form oxides and/or chalcogenides of one or more of a variety of elements or mixtures of elements. Examples of such oxides include, but are not limited to, silica (SiO₂), alumina (Al₂O₃), aluminosilicates, titania (TiO₂), and combinations thereof. The ceramic precursor precipitates (polymerizes) to form the inorganic (ceramic) material that encases the micelles in the micellar assemblies. The first level of order corresponds to the ordering of the micelles themselves into micellar assemblies or arrays. This is 1) referred to in the art as “short-range order,” 2) described by terms like “hexagonal,” “cubic,” and “lamellar” organization, and 3) occurs on a length scale of approximately 1-50 nm. The second level of order is the long range order of the space occupied by the micellar assemblies. This is the “orientation” and can be affected by the multiple fields. In addition, the second level of order can include spatial positioning of nanoparticles. The application of multiple fields can induce additional levels of structural ordering when different field types are applied and/or such fields are applied with varying directionality and/or field strength.

In some embodiments, the hierarchically-ordered complex structure is calcined (i.e., heated in an oxygen-containing environment) to remove the organic templating agent. Such calcining typically occurs at a temperature between 250° C. and 900° C., the lower temperature being dependent upon the oxidation of the organic template and the upper temperature being dependent upon the onset of sintering which destroys the nanometer level order. In some or other embodiments, these species can be removed in chemically alternative ways. Typically, removal of such organic templating agents provides for mesoporosity in the structure. The size of such mesoporosity can be tuned by careful selection of the organic templating agent and other conditions as known in the art.

In some embodiments of the present invention, the complex precursor mixture can be a combination of two or more subordinate complex precursor mixtures, each comprising pre-assembled elongated micelles and one or more ceramic or ceramic precursor material. In such embodiments, the micelle and/or ceramic precursor materials can be chosen to be differentially responsive to the external fields applied to the resulting mixture.

In some embodiments, the complex precursor mixture further comprises a plurality of particles dispersed within it. In some embodiments, such particles have magnetic properties. Suitable particles include, but are not limited to magnetite (Fe₃O₄), Fe, Co, Ni, Fe₂O₃, Fe₂CoO₄, CrO₂, and combinations thereof. Generally, such particles, when present, are differentially responsive, relative to the to the at least two external fields. Such particles generally comprise an average diameter between about 1 nm and about 100 μm, and more typically between about 1 nm and about 1 μm.

In some embodiments, the at least two external fields used to direct the structural assembly of the hierarchically-ordered complex structures are applied simultaneously, whereas in other embodiments they may be applied sequentially. For the formation of intricate structures, a combination of fields of varying type, direction, and strength may be applied in both simultaneous and sequential application over a period of time so as to provide for a desired structural ordering.

Magnetic fields, as used in accordance with the methods of the present invention, generally comprise a field strength that ranges from about 100 Gauss (G) or 0.01 Tesla (T) to about 10,000 G or 10 T. Such magnetic fields can be rotating magnetic fields, stationary magnetic fields, or combinations of the two.

Electric fields, as used in accordance with the methods of the present invention, generally comprise a field strength that ranges from about 10 V/m to about 1,000 V/m, and can be generated by alternating electric current (AC electric fields), direct electric current (DC electric fields), or combinations of the two. Such electric fields are defined herein as having low electric field strength.

In some embodiments, additional stimuli (structure-directing forces) may be employed in addition to the external fields. Such additional stimuli include, but are not limited to, surface effects, evaporation effects, thermal gradients, and physical confinement effects.

The present invention is also directed toward novel composites, structures, and articles of manufacture made by the above-described processes. In some embodiments, such structures are composites of two or more such hierarchically-ordered complex substructures. In additional or other embodiments, such hierarchically-ordered complex substructures are combined, or integrated into other structures would not be considered hierarchically-ordered complex structures taken separately. In some embodiments, the other structures are patterned substrates in which the hierarchically-ordered complex substructures are formed.

### EXAMPLES

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### Example 1

This Example serves to illustrate how a 1-D, hierarchically-ordered complex structure can be prepared using a combination of an electric field and a magnetic field in accordance with the methods of the present invention. This particular structure comprises 3-level (tertiary) ordering, the first level being in the mesoscale regime. More specifically, this Example describes the steps used to prepare fibers (10-20 μm×10-20 μm×1 cm or longer) of mesoporous silica with embedded magnetite nanoparticles (individual nanoparticles are ˜50 nm in diameter). The mesoporous silica contains hexagonally packed cylindrical channels with diameters ˜2-4 nm.

A precursor solution was prepared by mixing a quantity of an organic templating agent (CTAC), a quantity of ceramic precursor (TEOS, which yields silica), acid (HCl), and a quantity of magnetic nanoparticle together in a solvent (water). The mixture used in this Example comprised 0.24 M CTAC, 1.08 M TEOS and 400 g/L magnetite nanoparticles in pH 0 water. The relative concentrations and nanoparticle loading can be varied.

An experimental apparatus was filled with the precursor solution. The experimental apparatus consisted of a removable capillary (silica, 25-150 μm inner diameter, 10 cm length in this work) connected at both ends to reservoirs which hold the precursor solution. Different capillary sizes and wall compositions can be used.

External stimuli/fields were applied. In this Experiment, electric and magnetic fields were applied separately or combined and applied simultaneously as follows:

A) A DC electric field (E ˜10-10000 V/m, AC with a DC offset is also valid) was applied through metal electrodes inserted into each of the fluid reservoirs. In the Example described here, a 100 V/m (100 V/10 cm) field was applied using a Keithley model 2400 power supply.

B) A magnet was positioned along the capillary where spatial localization of the nanoparticles was desired to produce a magnetic field of strength 100 G (0.01 T).

Time was allowed (1 h to 1 day) for the silica material to form, after which time the silica material was removed from the capillary and dried in air. The material was then heated in air to at least 400° C. (600° C. with a ramp rate of 1° C./min was used for this Example).

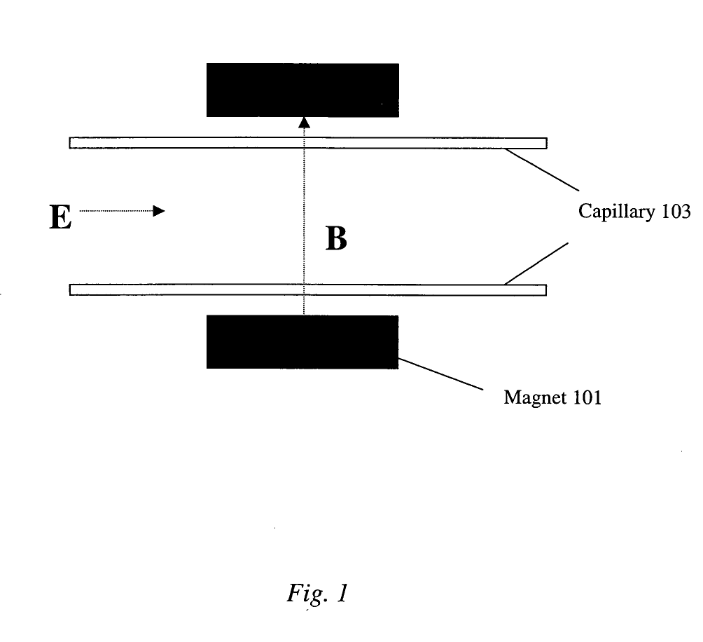

Referring to FIG. 1, a magnet 101 can be applied to the capillary 103 of the experimental apparatus described above to generate a magnetic field “B” that is perpendicular to an electric field “E.” Depending upon on the fields applied, very different structures were obtained. The four scenarios and their outcomes are outlined below.

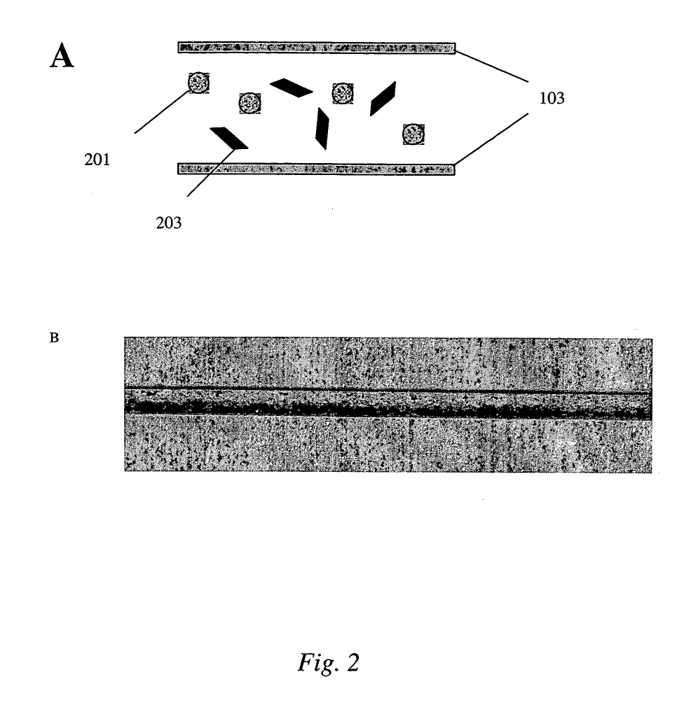

1) Referring to FIG. 2A, a control scenario is depicted wherein no external field is applied. In the absence of external fields, the magnetite particles 203 and silica particles 201 are randomly oriented and remain so upon gelation and subsequent calcination, as depicted in the micrograph shown in FIG. 2B.

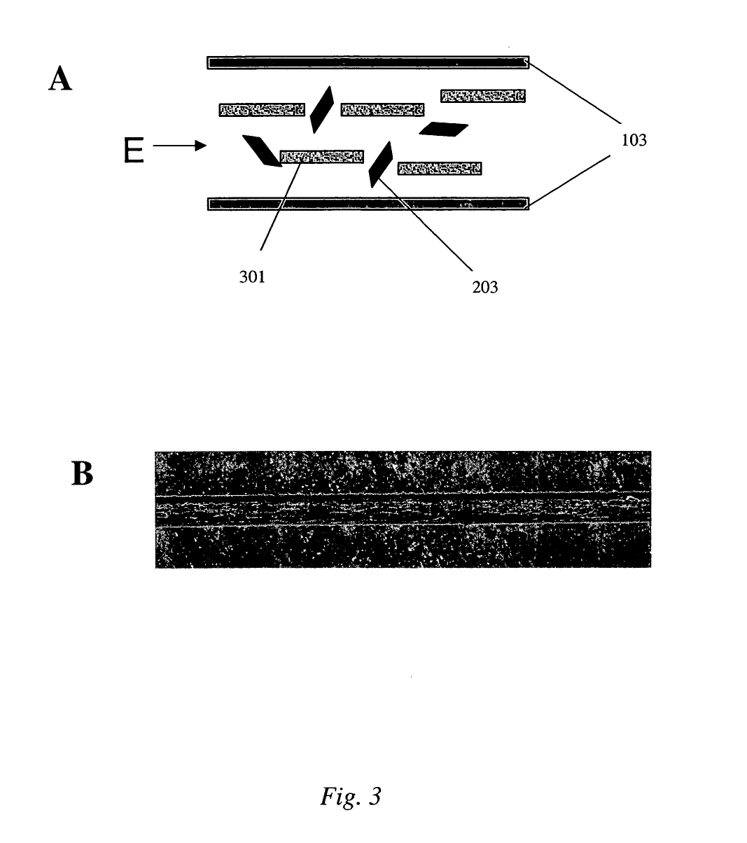

2) Referring to FIG. 3A, a scenario is depicted wherein only an electric field “E” is applied. Elongated silica fibers 301 form, and as only the elongated silica fibers 301 are directionally responsive to this field, it is only these fibers that are oriented. These fibers, of course, also comprise mesoscale structure (porosity). FIG. 3B depicts a micrograph of the calcined product.

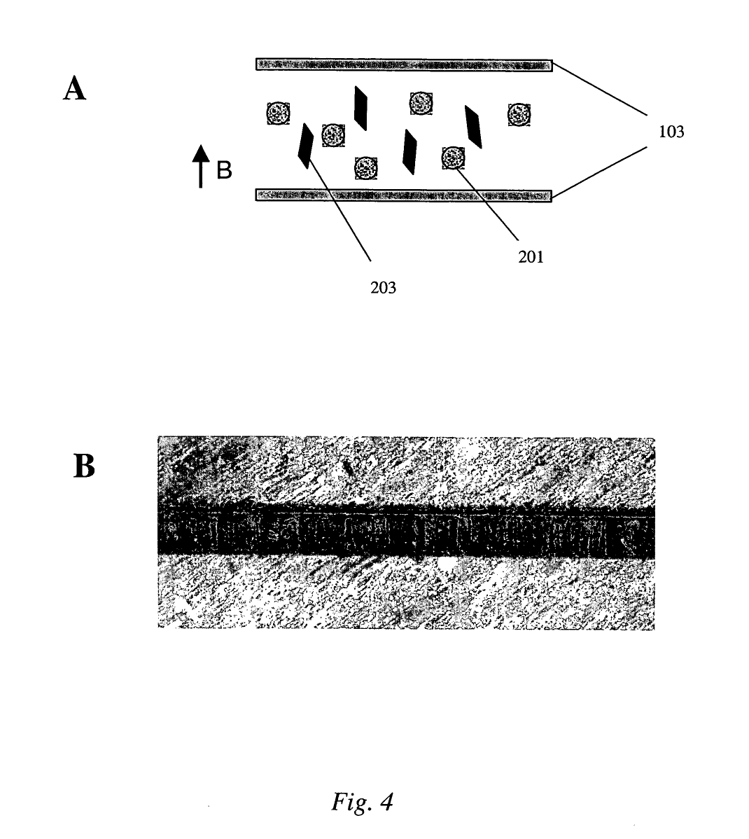

3) Referring to FIG. 4A, a scenario is depicted wherein only a magnetic field “B” is applied. As only the magnetite particles 203 are responsive to this field, they alone align and agglomerate in the direction of the applied field. FIG. 4B depicts a micrograph of the calcined product showing magnetite striations interspersed with randomly oriented silica particles.

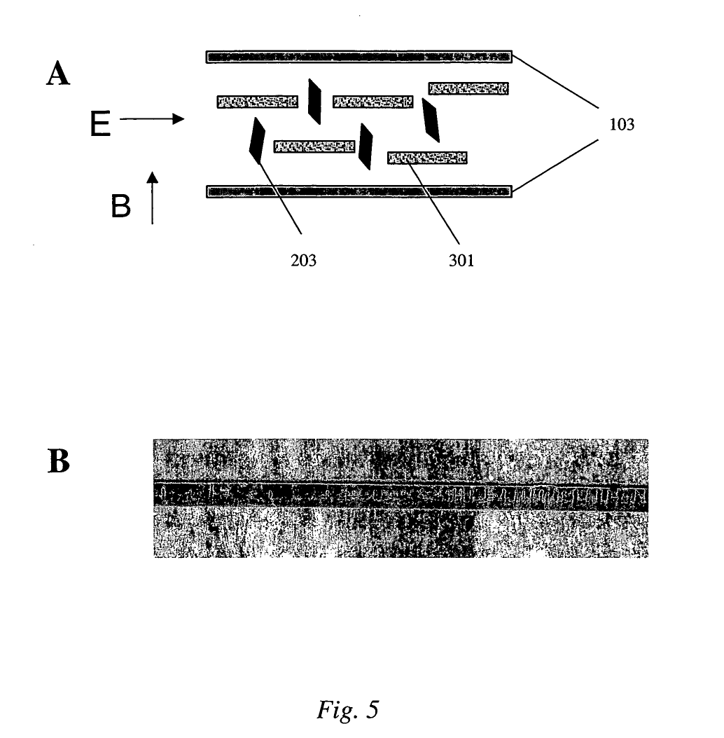

4) Referring to FIG. 5A, a scenario is depicted wherein both an electric field “E” and a magnetic field “B” are applied perpendicularly to each other. As the elongated silica fibers 301 are responsive to the electric field, and the magnetite particles 203 are responsive to the magnetic field, magnetite striations are formed and aligned perpendicularly to the silica fibers as shown in FIG. 5B. Such a calcined product represents a complex hierarchically-ordered structure by virtue of having differentially-alignable components of differing composition (i.e., silica and magnetite).

### Example 2

This example serves to illustrate how the field-assisted assembly of 1-D hierarchically-ordered complex structures illustrated in Example 1 can be adapted for synthesis of 3-D hierarchically-ordered complex structures.

As in Example 1, a complex precursor mixture can be prepared comprising amphiphilic surfactant (CTAC), silica precursor (TEOS), magnetite particles, acid, and water. Elongated micellar assemblies spontaneously form with silica precursor in their interstitial channels. This silica precursor begins to polymerize into silica upon acidification and the elongated micellar assemblies begin to further assemble into elongated silica fibers. Generally, a recipe is chosen so that a monolithic gel is formed (usually an ethanol-based solution). This mixture can then be placed in a container to provide macroscopic shape (one level of ordering) after gelation. The container also allows application of the electric field and magnetic fields in different directions. The fields can then be activated and the precursor mixture allowed to gel.

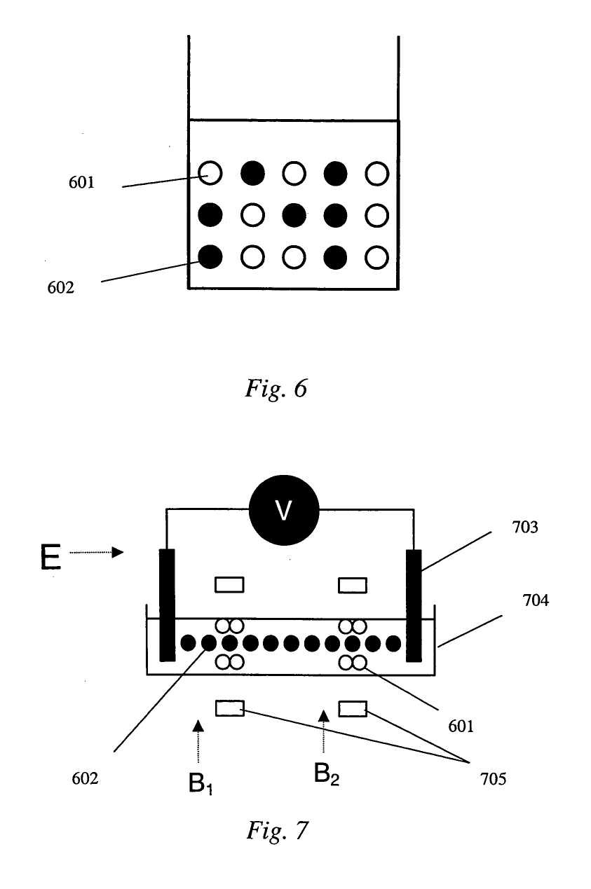

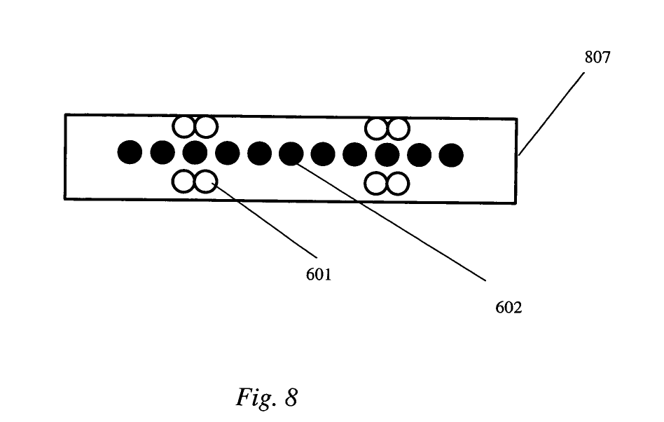

Referring to FIG. 6, the mixture comprises an aqueous dispersion of magnetite particles 601 and silica particles 602. Referring to FIG. 7, this is placed in container 704 and exposed to an electric field E and magnetic fields B₁, B₂, etc. by the action of electrodes 703 and magnets 705, respectively. The field-responsive particles adopt intermediate size structure in 3 dimensions within the macroscopic shape of the gel 807, as shown in FIG. 8. Mesoscopic structure is provided within the surfactant-templated nanochannels of the elongated silica fibers. Upon calcination, these mesostructures become mesopores, as the surfactant is burned out. Structural architecture is limited only by the ability to induce field-directed orientation of the structural subcomponents of the mixture.

In conclusion, the present invention represents a significant advance over the prior art in that it provides for a generally universal method of making such hierarchically ordered complex structures by using a multiplicity of external fields to direct ordering in one or more size regimes and in one or more dimensions.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

1. A method for forming at least one hierarchically-ordered complex composite comprising the steps of:
a) providing a complex precursor mixture, the mixture comprising:
i) at least one solvent;
ii) a quantity of at least one organic templating agent;
iii) a quantity of at least one ceramic precursor; and
iv) a quantity of at least one acid;
b) applying a combination of at least two external fields, oriented in at least two different directions, to the complex precursor mixture; and
c) forming the at least one hierarchically-ordered complex composite from the complex precursor mixture, wherein the at least two external fields provide directionality and organization to the hierarchically-ordered complex composite formation.

2. The method of claim 1, wherein the at least two external fields are selected from the group consisting of electric fields, magnetic fields, shear-flow fields, and combinations thereof.

3. The method of claim 1, wherein the complex precursor mixture further comprises a plurality of particles dispersed within it; wherein the plurality of particles comprises at least one material selected from the group consisting of magnetite, Fe, Co, Ni, Fe₂O₃, Fe₂CoO₄, CrO₂, and combinations thereof; and wherein the particles have an average diameter between about 1 nm and about 1 μm.

4. The method of claim 1, wherein the solvent is water.

5. The method of claim 1, wherein the organic templating agent is an amphiphilic species selected from the group consisting of surfactants, lipids, amphiphilic block copolymers, proteins, and combinations thereof.

6. The method of claim 1, wherein the organic templating agent is a surfactant selected from the group consisting of CTAC, polyethylene oxide-polypropylene oxide-polyethylene oxide triblock copolymers, cetyltrimethylammonium bromide, cetyltrimethylammonium tosylate, and combinations thereof.

7. The method of claim 1, wherein the ceramic precursor is selected from the group consisting of metal salts, organometallic species, and combinations thereof

8. The method of claim 1, wherein the ceramic precursor is an organometallic species selected from the group consisting of TEOS, sodium silicate, colloidal silica, aluminum butoxide, titanium ethoxide, titanium isopropoxide.

9. The method of claim 1, wherein the acid is selected from the group consisting of HCl, HBr, HF, HI, acetic acid, HNO₃, H₂SO₄, HPO₄, HClO₄, and combinations thereof.

10. The method of claim 1, wherein the at least two external fields are applied in a manner selected from the group consisting of simultaneously, sequentially, and combinations thereof.

11. The method of claim 1, wherein the at least two external fields comprise at least one electric field produced by electrode configurations designed to produce electric field lines along a desired direction, and wherein the at least one electric field is of low electric field strength and is selected from the group consisting of AC electric fields, DC electric fields, and combinations thereof.

12. The method of claim 1, wherein the at least two external fields comprise at least one magnetic field, wherein the at least one magnetic field is selected from the group consisting of rotating magnetic fields, stationary magnetic fields, and combinations thereof.

13. The method of claim 1, wherein the at least one hierarchically-ordered complex composites possesses a dimensionality selected from the group consisting of one-dimensional, two-dimensional, three-dimensional, and combinations thereof; and wherein the at least one hierarchically-ordered complex composite possesses an order of dimensional hierarchy selected from the group consisting of first order, second order, third order, and combinations thereof.

14. The method of claim 1, further comprising a step of calcining the hierarchically-ordered complex composite to form a calcined hierarchically-ordered complex composite, wherein the calcined hierarchically-ordered complex composite possesses mesoporosity.

15. A method for forming at least one hierarchically-ordered complex composite comprising the steps of:
a) providing a complex precursor mixture, the mixture comprising:
i) water;
ii) a quantity of at least one organic templating agent;
iii) a quantity of at least one ceramic precursor; and
iv) a quantity of at least one protic acid;
b) applying a combination of at least two different external field types, oriented in at least two different directions, to the complex precursor mixture; and
c) forming the at least one hierarchically-ordered complex composite from the complex precursor mixture, wherein the at least two different types of external fields provide directionality and hierarchical organization to the formation of the hierarchically-ordered complex composites by differential interaction with components of the complex precursor mixture.

16. The method of claim 15, wherein the at least two different external field types are selected from the group consisting of electric fields, magnetic fields, shear-flow fields, and combinations thereof.

17. The method of claim 15, wherein the complex precursor mixture further comprises a plurality of particles dispersed within it, and wherein the particles have an average diameter between about 1 nm and about 1 μm.

18. The method of claim 15, wherein the organic templating agent is an amphiphilic species selected from the group consisting of surfactants, lipids, amphiphilic block copolymers, proteins, and combinations thereof.

19. The method of claim 15, wherein the ceramic precursor is selected from the group consisting of metal salts, organometallic species, and combinations thereof

20. The method of claim 15, wherein the at least two external fields are applied in a manner selected from the group consisting of simultaneously, sequentially, and combinations thereof.

21. The method of claim 15, wherein the hierarchically-ordered complex composites possesses a dimensionality selected from the group consisting of one-dimensional, two-dimensional, three-dimensional, and combinations thereof; and wherein the hierarchically-ordered complex composites possesses an order of dimensional hierarchy selected from the group consisting of first order, second order, third order, and combinations thereof.

22. The method of claim 15, wherein the at least two external fields comprise at least one electric field produced by electrode configurations designed to produce electric field lines along a desired direction, and wherein the at least one electric field is of low electric field strength and is selected from the group consisting of AC electric fields, DC electric fields, and combinations thereof.

23. The method of claim 15, wherein the at least two external fields comprise at least one magnetic field, wherein the at least one magnetic field is selected from the group consisting of rotating magnetic fields, stationary magnetic fields, and combinations thereof.

24. The method of claim 15, further comprising a step of calcining the hierarchically-ordered complex composite to form a calcined hierarchically-ordered complex composite, wherein the calcined hierarchically-ordered complex composite possesses mesoporosity.

25. A hierarchically-ordered complex composite formed by a method comprising the steps of:
a) providing a complex precursor mixture, the mixture comprising:
i) water;
ii) a quantity of at least one organic templating agent;
iii) a quantity of at least one ceramic precursor; and
iv) a quantity of at least one acid;
b) applying a combination of at least two different external field types, oriented in at least two different directions, to the complex precursor mixture; and
c) forming the hierarchically-ordered complex composite from the complex precursor mixture, wherein the at least two different types of external fields provide directionality and hierarchical organization to the formation of the hierarchically-ordered complex composites by differential interaction with components of the complex precursor mixture.

26. The hierarchically-ordered complex composite of claim 25, wherein the at least two different external field types are selected from the group consisting of electric fields, magnetic fields, shear-flow fields, and combinations thereof.

27. The hierarchically-ordered complex composite of claim 25, wherein the complex precursor mixture further comprises a plurality of particles dispersed within it; wherein the plurality of particles comprise at least one material selected from the group consisting of magnetite, Fe, Co, Ni, Fe₂O₃, Fe₂CoO₄, CrO₂, and combinations thereof; and wherein the particles have an average diameter between about 1 nm and about 1 μm.

28. The hierarchically-ordered complex composite of claim 25, wherein the organic templating agent is an amphiphilic species selected from the group consisting of surfactants, lipids, amphiphilic block copolymers, proteins, long chain alcohols, and combinations thereof.

29. The hierarchically-ordered complex composite of claim 25, wherein the ceramic precursor is selected from the group consisting of metal salts, organometallic species, and combinations thereof

30. The hierarchically-ordered complex composite of claim 25, wherein the at least two external fields are applied in a manner selected from the group consisting of simultaneously, sequentially, and combinations thereof.

31. The hierarchically-ordered complex composite of claim 25, wherein the at least two external fields comprise at least one electric field produced by electrode configurations designed to produce electric field lines along a desired direction, and wherein the at least one electric field is of low electric field strength and is selected from the group consisting of AC electric fields, DC electric fields, and combinations thereof.

32. The hierarchically-ordered complex composite of claim 25, wherein the at least two external fields comprise at least one magnetic field, wherein the at least one magnetic field is selected from the group consisting of rotating magnetic fields, stationary magnetic fields, and combinations thereof.

33. The hierarchically-ordered complex composite of claim 25, wherein the hierarchically-ordered complex composite possesses a dimensionality selected from the group consisting of one-dimensional, two-dimensional, three-dimensional, and combinations thereof; and wherein the hierarchically-ordered complex composites possesses an order of dimensional hierarchy selected from the group consisting of first order, second order, third order, and combinations thereof.

34. The hierarchically-ordered complex composite of claim 25, further comprising a step of calcining the hierarchically-ordered complex composite to form a mesoporous hierarchically-ordered complex composite.
